(19) United States
(12) Patent Application Publication
(10) Pub. No.: US 2013/0307794 A1
(43) Pub. Date: Nov. 21, 2013

(54) TOUCHPANEL DEVICE, METHOD OF DISPLAY CONTENT MODIFICATION IN TOUCHPANEL DEVICE, AND NON-TRANSITORY COMPUTER READABLE STORAGE MEDIUM

(71) Applicant: FUJI XEROX CO., LTD., Tokyo (JP)

(72) Inventor: Jun NAGUMO, Kanagawa (JP)

(73) Assignee: FUJI XEROX CO., LTD., Tokyo (JP)

(21) Appl. No.: 13/692,378

(22) Filed: Dec. 3, 2012

(30) Foreign Application Priority Data
May 15, 2012 (JP) 2012-111549

(51) Int. Cl. G06F 3/041

(52) U.S. Cl. CPC G06F 3/041
USPC 345/173

(57) ABSTRACT

A touchpanel device includes a detector that detects an operation of changing touch positions of two points on a touchpanel arranged on a display panel, with the two points kept being touched, and a modifier that performs a size modification on content displayed on a display provided in the display panel, in accordance with a direction in which the positions of the two points are changed.

### CROSS-REFERENCE TO RELATED APPLICATIONS

This application is based on and claims priority under 35 USC 119 from Japanese Patent Application No. 2012-111549 filed May 15, 2012.

### BACKGROUND

(i) Technical Field

The present invention relates to a touchpanel device, a method of display content modification in the touchpanel device, and a non-transitory computer readable storage medium.

(ii) Related Art

In a related art host device, an operation input to display content is typically received by a touchpanel overlaid on the display panel in the host device. For example, an operation screen having plural buttons is displayed on the display panel. When a touch operation is performed on the touchpanel, a button having coordinates of a touch position is identified, and a process assigned to the identified button is then executed.

### SUMMARY

According to an aspect of the invention, there is provided a touchpanel device including a detector that detects an operation of changing touch positions of two points on a touchpanel arranged on a display panel with the two points kept being touched, and a modifier that performs a size modification on content displayed on a display provided in the display panel, in accordance with a direction in which the positions of the two points are changed.

### BRIEF DESCRIPTION OF THE DRAWINGS

Exemplary embodiments of the present invention will be described in detail based on the following figures, wherein:

FIG. 1 is a functional block diagram of a touchpanel device of an exemplary embodiment;

FIG. 2 illustrates a display example on a display panel;

FIG. 3 illustrates an example of a size modification of display content of a destination list through a pinch operation in a vertical direction;

FIG. 4 illustrates an example of a size modification of the display content of the destination list through a pinch operation in a horizontal direction;

FIG. 5 illustrates an example of a size modification of display content of a cumulative document list through a pinch operation in a horizontal direction;

FIGS. 6A and 6B illustrate an example of an image indicating a direction in which the size modification of the display content of an element is enabled; and

FIG. 7 illustrates a menu screen to which the size modification of the display content of the element is applied using a pinch operation.

### DETAILED DESCRIPTION

An exemplary embodiment of the present invention is described with reference to the drawings.

Described below is a multi-function apparatus including a touchpanel device of the exemplary embodiment. The multi-function apparatus has plural functions including document printing, copying, and facsimile transmission, for example.

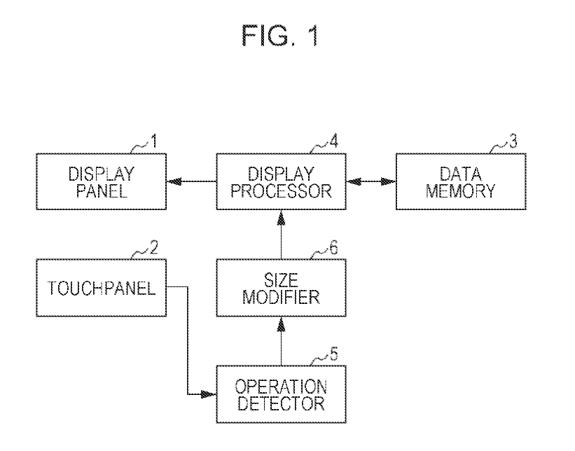

FIG. 1 is a functional block diagram of the touchpanel device of the exemplary embodiment.

The touchpanel device of the exemplary embodiment includes functional elements including display panel 1, touchpanel 2, data memory 3, display processor 4, operation detector 5, and size modifier 6.

The display panel 1 is a planer panel that displays a variety of information. The display panel 1 may include a liquid-crystal display panel, for example.

The touchpanel 2 is a light-transmissive planer panel that is overlaid on a display surface of the display panel 1. The touchpanel 2 has a function of detecting a touch position (a touch position of an object on the touchpanel 2), and outputs a signal responsive to the touch position. The touchpanel 2 may employ one of a variety of methods working on various operating principles, for example, employs a resistive screen method, or an electrostatic capacitance method.

The data memory 3 stores data of an element forming a display displayed by the display panel 1. For example, the elements include a list of transmission destinations, a list of print documents, an image of a scanned document, a photograph, a text area displaying text such as a description, and a variety of buttons. For example, data of the elements include identification information that identifies an element, type information that indicates a type of the element, content information that indicates display content of the element, area information that indicates a display area of the element, and modification enable/disable flag that indicates the size modification of the display content of the element is enabled or disabled.

The display processor 4 reads the data of the element from the data memory 3, visualizes the element, and displays the visualized element.

The operation detector 5 detects an operation (also referred to as a “pinch operation”) that changes touch positions of two points on the touchpanel 2 with the two points kept in a touch state on the touchpanel 2.

In response to detection of the pinch operation by the operation detector 5, the size modifier 6 performs the size modification on the display content of the element selected from within the display on the display panel 1 in a direction of change in a positional relationship between two points responsive to the pinch operation. More specifically, if a pinch operation changing the positional relationship between the two points in a vertical direction (in a Y axis direction on an XY plane) is detected, the size modification is performed in the vertical direction on the display content of the element. If a pinch operation changing the positional relationship between the two points in a horizontal direction (in an X axis direction on the XY plane) is detected, the size modification is performed in the horizontal direction on the display content of the element. If a pinch operation changing the positional relationship between the two points in a slant direction, i.e., a pinch operation composed of a component in the vertical direction and a component in the horizontal direction is detected, the size modification is performed in both the vertical direction and the horizontal direction on the display content of the element. The size modification is thus performed on the display content of the element in the slant direction.

The operation of the size modifier 6 is further described.

In response to coordinates of the touch positions of the two points in the pinch operation, the size modifier 6 selects a target element having the display content that is to be size-modified. In the exemplary embodiment, the size modifier 6 selects the element having in a display area thereof coordinates of the two touch positions related to the pinch operation. More specifically, the size modifier 6 compares the coordinates of the two touch positions with area information of each element. If an element satisfying the condition is found, and the size modification of the display content of the element is enabled, the size modifier 6 selects the element as a target of the size modification. Whether the size modification of the display content of the element is enabled or not is determined by referencing a modification enable/disable flag of each element.

The size modifier 6 calculates an amount of change in the positional relationship of the tow points responsive to the pinch operation in each of the vertical direction and the horizontal direction. More specifically, the size modifier 6 calculates a vertical distance y1 between the two points prior to the pinch operation, and a vertical distance y2 between the two points subsequent to the pinch operation, and calculates a difference (=y2−y1) as an amount of change in the vertical direction in the pinch operation. The size modifier 6 also calculates a horizontal distance x1 between the two points prior to the pinch operation, and a horizontal distance x2 between the two points subsequent to the pinch operation, and calculates a difference (=x2−x1) as an amount of change in the horizontal direction in the pinch operation.

The size modifier 6 performs the size modification on the display content of the element selected as a target of the size modification in accordance with the amount of change in the vertical direction and the horizontal direction in the positional relationship responsive to the pinch operation. More specifically, the size modifier 6 performs the size modification in the vertical direction on the display content of the target element in response to the amount of change in the vertical direction in the pinch operation. The size modifier 6 performs the size modification in the horizontal direction on the display content of the target element in response to the amount of change in the horizontal direction in the pinch operation. The size modifier 6 notifies the display processor 4 of information of modification results. The size modifier 6 thus causes the display processor 4 to update the display content of the target element included in the display displayed on the display panel 1 to display content that has undergone the size modification.

A specific example of the size modification of the display content of the element responsive to the pinch operation is described below.

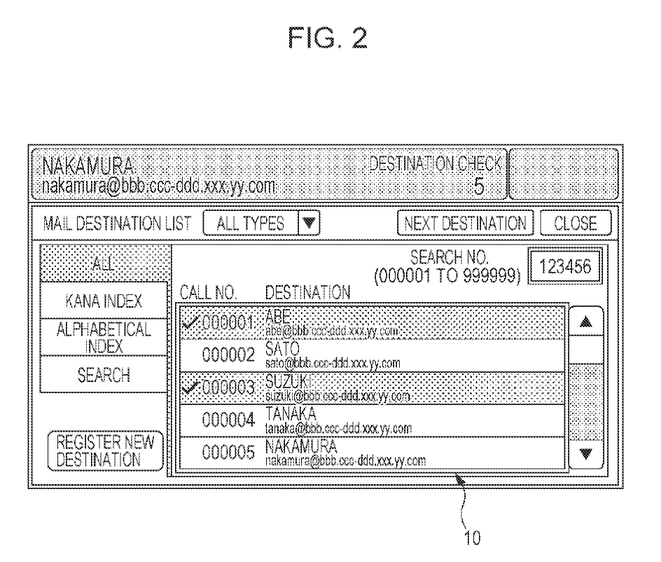

FIG. 2 illustrates a display example on a screen of the display panel 1.

The screen of FIG. 2 indicates a destination of an e-mail to be selected. The element included in the display on the screen is a destination list 10. The destination list 10 in an initial state thereof includes horizontally elongated ladder buttons that are vertically juxtaposed, and respectively represent destinations. A ladder button not appearing in a vertical display range may be displayed by performing a vertical scroll operation. Each ladder button displays items of a name of a destination, mail address, and the like.

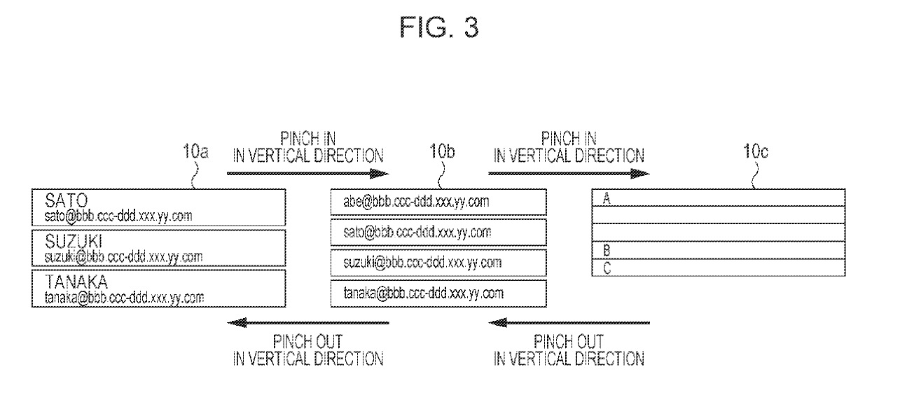

Described below with reference to FIG. 3 is the size modification performed on the display content of the destination list 10 responsive to the pinch operation in the vertical direction. FIG. 3 illustrates the size modification performed on the display content of the destination list 10 responsive to the pinch operation in the vertical direction.

A destination list 10a is in an initial state. If a pinch-in operation in the vertical direction (a pinch operation to narrow a separation in the vertical direction between the two points in the positional relationship) is performed on the destination list 10a, the length (height) of each ladder button in the vertical direction is shortened as represented by a destination list 10b. If a pinch-in operation is performed in the vertical direction on the destination list 10b, the length of each ladder button in the vertical direction is further shortened and a destination list 10c results.

If the separation (distance) between the two points is narrowed in the vertical direction, the length (height) of each ladder button is shortened. In this way, the number of ladder buttons displayed in a list display increases. A listing capacity of the destination list 10 thus increases. If a desired ladder button is out of the list display, a vertical scroll operation to cause the desired ladder button to be displayed may be performed. In such a case, an amount of scroll movement involved in the vertical scroll operation is reduced.

If a vertical pinch-out operation is performed in the vertical direction on the destination list 10c (a pinch operation to widen the separation between the two points in the vertical direction in the positional relationship), the destination list 10b is displayed. If the vertical pinch-out operation is further performed on the destination list 10b, the destination list 10a is displayed.

If the separation (distance) between the two points in the vertical direction is widened, the length (height) of each ladder button is increased in the vertical direction. The area of each ladder button in the list display increases, and a larger number of characters (more information) is displayed. Characters may also be enlarged in size, leading to increased legibility.

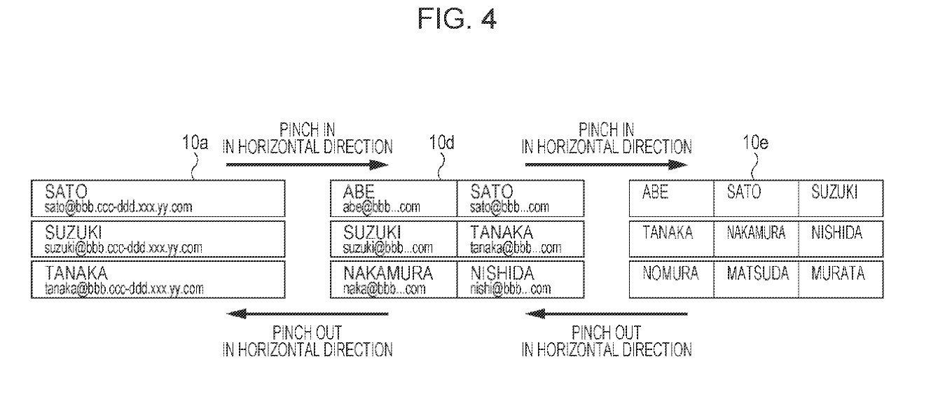

Described below with reference to FIG. 4 is the size modification performed on the display content of the destination list 10 responsive to the pinch operation in the horizontal direction. FIG. 4 illustrates the size modification performed on the display content of the destination list 10 responsive to the pinch operation in the horizontal direction.

A destination list 10a is in an initial state. If a pinch-in operation in the horizontal direction (a pinch operation to narrow a separation in the horizontal direction between the two points in the positional relationship) is performed on the destination list 10a, the length (width) of each ladder button in the horizontal direction is shortened as represented by a destination list 10d. If a pinch-in operation is performed in the horizontal direction on the destination list 10d, the length of each ladder button in the horizontal direction is further shortened and a destination list 10e is displayed.

If the separation (distance) between the two points is narrowed in the horizontal direction, the length (width) of each ladder button is shortened. In this way, plural ladder buttons are arranged in the horizontal direction and the number of ladder buttons in the list display increases. A listing capacity of the destination list 10 thus increases. If a desired ladder button is out of the list display, a horizontal scroll operation to cause the desired ladder button to be displayed may be performed. In such a case, an amount of scroll movement involved in the horizontal scroll operation is reduced.

If a horizontal pinch-out operation is performed on the destination list 10e (a pinch operation to widen the separation between the two points in the horizontal direction in the positional relationship), the destination list 10d is displayed. If the horizontal pinch-out operation is performed on the destination list 10d, the destination list 10a is displayed.

If the separation (distance) between the two points in the horizontal direction is widened, the length (width) of each ladder button is increased in the horizontal direction. The area of each ladder button in the list display increases, and a larger number of characters (more information) is displayed on the ladder button. Characters may be enlarged in size, leading to increased legibility. Information including some characters, such as an e-mail or a telephone number, is fully displayed without any missing portion thereof.

The touchpanel device of the exemplary embodiment performs the size modification in a manner different from the vertical pinch operation to the horizontal pinch operation.

In the above discussion, the vertical pinch operation and the horizontal pinch operation are performed separately. If a pinch operation is performed in a slant direction, the size modification in the vertical direction and the size modification in the horizontal direction are performed respectively using a vertical component and a horizontal component in the slant direction in the pinch operation. The size modification is performed in the slant direction.

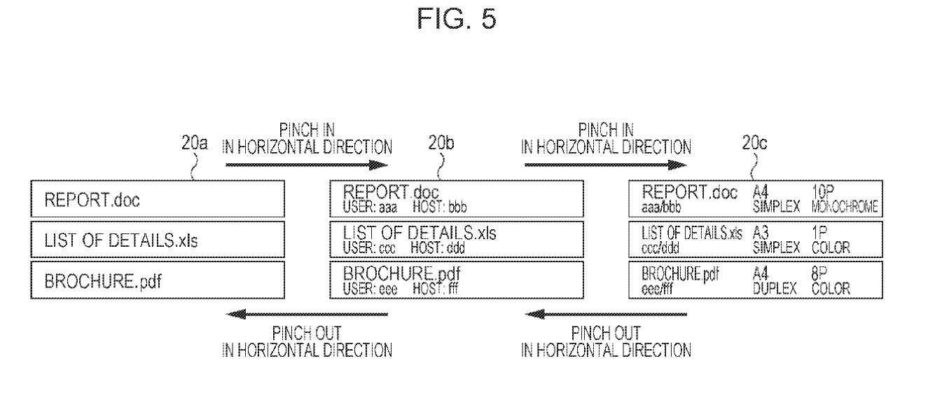

In the above discussion, the vertical length (height) of each ladder button is modified in response to the pinch operation in the vertical direction and the horizontal length (width) of each ladder button is modified in response to the pinch operation in the horizontal direction. The size modifications in the vertical direction and the size modification in the horizontal direction are of the same property (because the size modifications are related to length). As described below with reference to FIG. 5, size modifications of different properties are performed from the vertical pinch operation to the horizontal pinch operation.

FIG. 5 illustrates an example of the size modification of display content of a cumulative document list 20 responsive to a pinch operation in the horizontal direction. The cumulative document list 20 in an initial state thereof includes horizontally elongated ladder buttons that are vertically juxtaposed, and respectively represent cumulative documents. A ladder button not appearing in a vertical display range may be displayed by performing a vertical scroll operation.

Each ladder button in a cumulative document list 20a in an initial state thereof includes a name of each cumulative document. If a pinch-in operation is performed in the horizontal direction on the cumulative document list 20a, a cumulative document list 20b is displayed. The cumulative document list 20b includes a ladder button having a display of a user (owner) and a host name (storage destination). If a horizontal pinch-in operation is performed on the cumulative document list 20b, a cumulative document list 20c is displayed. The cumulative document list 20c includes a ladder button having additionally a display of a print format (information relating to duplex/simplex printing and monochrome/color printing).

More specifically, if the separation (distance) between the two points is shortened, the number of items displayed within each ladder button is increased. Since a variety of information is displayed in each ladder button in the list, retrieval performance is increased.

On the other hand, if a horizontal pinch-out operation is performed on the cumulative document list 20c, the cumulative document list 20b is displayed. If the horizontal pinch-out operation is performed on the cumulative document list 20b, the cumulative document list 20a is displayed again.

More specifically, if the separation (distance) between the two points is increased, the number of items displayed in each ladder button is decreased. Since an area used to display a single item is increased, information having some size is displayed without any missing portion thereof. Since characters of each item are enlarged in size, legibility increases.

In this example discussed herein, the length (width) of each ladder button remains unchanged in response to the horizontal pinch operation, but the character size is modified. An amount of information displayable is varied. The number of items to be displayed in the ladder button is thus modified.

The size modification on the cumulative document list 20 responsive to the pinch operation in the vertical direction is performed in a manner similar to that of modification of the length (height) of each ladder button of the destination list 10 in the vertical direction illustrated in FIG. 3. The discussion of the size modification on the cumulative document list 20 responsive to the pinch operation in the vertical direction is omitted herein.

The length (width) of each ladder button in the horizontal direction is not modified in the horizontal pinch operation, but the length (height) of each ladder button is modified in the vertical pinch operation. The size modifications responsive to the vertical pinch operation and the horizontal pinch operation are different from each other in property.

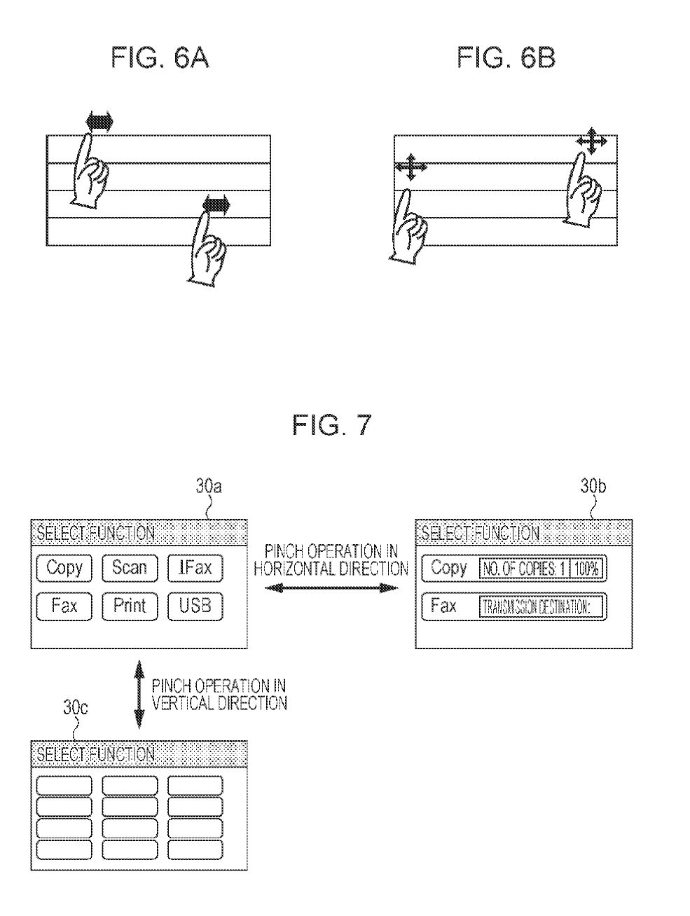

A modification of the touchpanel device is described below. In the modification of the touchpanel device, a user is notified of a direction in which the size modification of the display content of the element is enabled. Images displayed as illustrated in FIGS. 6A and 6B indicate directions in which the size modification of the display content of the element is enabled.

FIG. 6A illustrates an example of image which is enabled to be modified in size in the horizontal direction only. A guidance image of a horizontally-aligned arrow-headed bar is displayed to indicate that the size modification in the horizontal direction only is enabled (the pinch operation in the horizontal direction only is effective). The pinch operation in the vertical direction may be meaningless if all list items in the list display are displayed on the screen. In such a case, the guidance image of the horizontally-aligned arrow-headed bar notifies a user that the pinch operation in the horizontal direction only is meaningful.

FIG. 6B illustrates an example of image which is enabled to be modified in size in both the vertical direction and the horizontal direction. A guidance image of a vertically-aligned arrow-headed bar and a horizontally-aligned arrow-headed bar crossing each other is displayed to indicate that the size modification in the vertical direction and the horizontal direction is enabled (the pinch operation in vertical direction and the horizontal direction is effective).

The image of the arrow-headed bar is displayed as described below. When the two points are touched, the operation detector 5 (or the size modifier 6) determines whether the pinch operation in the vertical direction and the pinch operation in the horizontal direction are effective. In response to the determination results, the display processor 4 adds a display of a guidance image indicating the direction of the effective pinch operation at a position on the display panel 1 corresponding to the touch position (or in the vicinity of the touch position). A guidance image of a type other than the arrow-headed bar may be used. Any image is acceptable as long as the user who views the image can recognize the direction of the effective pinch operation.

With the guidance image additionally displayed in this way, the user may learn what a next possible step is when the two points are touched. Operability is improved.

FIG. 7 illustrates a menu screen 30 to which the size modification of display content of an element responsive to a pinch operation is applied. The menu screen 30 in an initial state includes six menu buttons (of two rows by three columns). A menu button not appearing on the screen is displayed by performing a vertical scroll operation (or a horizontal scroll operation).

The menu screen 30a is in the initial state thereof. If the pinch operation is performed in the horizontal direction on the menu screen 30a, a menu screen 30b is displayed. The menu screen 30b includes the menu buttons with the length (width) thereof changed in the horizontal direction. If the width of each menu button is increased in response to a pinch-out operation, the menu button may include a section that receives a setting of a variety of attribute values. The setting of an attribute value, which is performed by transitioning to a setting screen in related art, is performed on the menu screen. Operation of the touchpanel device is thus facilitated.

If the pinch operation is performed in the vertical direction on the menu screen 30a, a menu screen 30c is displayed. The menu screen 30c includes the menu buttons with the horizontal length (height) thereof varied. If the height of each menu button is decreased in response to a pinch-in operation, the number of menu buttons displayed on the screen is increased. The listing capacity of the menu screen 30 increases. A scroll operation of a small amount of scroll movement may still permit function selection (pressing of a desired menu button).

In the touchpanel device of the exemplary embodiment, the operation detector 5 detects a pinch operation that causes the touch positions to change with the two points kept in a touch state on the touchpanel 2. When the operation detector 5 detects the pinch operation, the size modifier 6 performs the size modification on the display content of the element included in the display on the display panel 1, in accordance with the direction of change in the positional relationship between the two points responsive to the pinch operation.

The user not only instructs the size modification to be performed on the display content of the element displayed on the display panel through the pinch operation, but also changes the manner of the size modification of the display content in accordance with the direction of the pinch operation.

If an amount of change in the positional relationship between the two points responsive to the pinch operation in the vertical direction is equal to or lower than a threshold value, the touchpanel device may not qualify the detected pinch operation as a pinch operation in the vertical direction, and may not perform the size modification on the display content of the element. Similarly, if an amount of change in the positional relationship between the two points responsive to the pinch operation in the horizontal direction is equal to or lower than a threshold value, the touchpanel device may not qualify the detected pinch operation as a pinch operation in the horizontal direction, and may not perform the size modification on the display content of the element. In this way, a slight degree of allowance is given to the pinch operation.

The size modification is performed on the display content with an area size of the element remaining unchanged. Alternatively, the area size of the element may be modified in concert with the size modification performed on the display content.

The touchpanel device may include a computer that includes hardware resources. The hardware resources of the computer include a central processing unit (CPU) that performs a variety of calculation processes, major storage devices including a random-access memory (RAM) that serves as a work area of the CPU, and a read-only memory (ROM) that stores basic control programs, auxiliary storage device that stores a variety of programs and data, an input and output interface that serves as an interface with an output device and an input device, and a communication interface. The output device is the display panel that outputs and displays a variety of information. The input device includes an operation button or a touchpanel, used by an operator in an input operation. The communication interface performs wired or wireless communications with another apparatus.

A program of the exemplary embodiment of the present invention is read from the auxiliary storage device or the like, and expanded onto the RAM. The CPU then executes the program. The function of the touchpanel device of the exemplary embodiment is thus implemented on the computer.

More specifically, the function of the detector of the exemplary embodiment is implemented by the operation detector 5, the function of the modifier of the exemplary embodiment is implemented by the size modifier 6, and the display processing unit of the exemplar embodiment is implemented by the display processor 4.

Each of the functions may be implemented using a dedicated hardware module instead of using software.

The touchpanel device arranged in the multi-function apparatus has been discussed. The present invention is not limited to this arrangement. The present invention is applicable to the touchpanel device arranged on a variety of apparatuses. If the touchpanel is arranged on a compact apparatus, such as a cell phone terminal, an amount and granularity of information displayed on the compact display panel may be freely modified by the user in a simple operation.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A touchpanel device, comprising:
a detector that detects an operation of changing touch positions of two points on a touchpanel arranged on a display panel, with the two points kept being touched; and
a modifier that performs a size modification on content displayed on a display provided in the display panel, in accordance with a direction in which the positions of the two points are changed.

2. The touchpanel device according to claim 1, wherein the modifier calculates an amount of change in positional relationship between the two points responsive to the operation in each of a first direction and a second direction, and in accordance with calculation results, performs at least one of the size modification on the content in the first direction responsive to the amount of change in the first direction and the size modification on the content in the second direction responsive to the amount of change in the second direction.

3. The touchpanel device according to claim 1, wherein the modifier sets, as a target of the size modification on the content, an element that includes, in a display area thereof, coordinates of the touch positions of the two points related to the operation.

4. The touchpanel device according to claim 2, wherein the modifier sets, as a target of the size modification on the display content, an element that includes, in a display area thereof, coordinates of the touch positions of the two points related to the operation.

5. The touchpanel device according to claim 1, comprising a display processor that performs a display process on the display panel,
wherein the display processor causes the display panel to display an image indicating a direction in which the size modification on the content is enabled.

6. The touchpanel device according to claim 2, further comprising a display processor that performs a display process on the display panel,
wherein the display processor causes the display panel to display an image indicating a direction in which the size modification on the display content of the element is enabled.

7. The touchpanel device according to claim 3, further comprising a display processor that performs a display process on the display panel,
wherein the display processor causes the display panel to display an image indicating a direction in which the size modification on the display content of the element is enabled.

8. The touchpanel device according to claim 4, further comprising a display processor that performs a display process on the display panel,
wherein the display processor causes the display panel to display an image indicating a direction in which the size modification on the display content of the element is enabled.

9. A method of display content modification in a touchpanel device, comprising:
detecting an operation of changing touch positions of two points on a touchpanel arranged on a display panel, with the two points kept being touched; and
performing a size modification on content displayed on a display provided in the display panel, in accordance with a direction in which the positions of the two points are changed.

10. A non-transitory computer readable medium storing a program causing a computer to execute a process of a touchpanel device, the process comprising:
detecting an operation of changing touch positions of two points on a touchpanel arranged on a display panel, with the two points kept being touched; and
performing a size modification on content displayed on a display provided in the display panel, in accordance with a direction in which the positions of the two points are changed.

11. A touchpanel device, comprising:
a display that displays a plurality of contents;
a detector that detects a direction in which an operation of changing touch positions of two points on a touchpanel arranged on the display is performed, with the two points kept being touched; and
a controller that controls a way of changing size and number of the plurality of contents displayed on the display, in accordance with the detected direction in which the operation is performed.

12. The touchpanel device according to claim 11, wherein the detector detects whether the operation of changing touch positions of two points is a pinching operation in the vertical direction or horizontal direction.

13. The touchpanel device according to claim 12, wherein the detector detects the operation of changing touch positions is performed in vertical direction if change in positional relationship between the two points responsive to the pinching operation in vertical direction is equal to or greater than a threshold value, and detects the operation of changing touch positions is performed in horizontal direction if change in positional relationship between the two points responsive to the pinching operation in horizontal direction is equal to or greater than a threshold value.

14. The touchpanel device according to claim 13, wherein the controller controls so that, if the detector detects that the operation is pinching operation performed in vertical direction, height of the displayed contents is varied, and if the detector detects that the operation of is pinching operation performed in horizontal direction, length of the displayed contents is varied.

15. The touchpanel device according to claim 13, wherein the controller controls so that, if the detector detects that the operation is pinching operation performed in vertical direction, height of the displayed contents is varied, and if the detector detects that the operation of is pinching operation performed in horizontal direction, number of items displayed within the displayed contents is varied.
